(19) United States
(12) Patent Application Publication
(10) Pub. No.: US 2003/0198010 A1
(43) Pub. Date: Oct. 23, 2003

(54) Portable computer system with external bay to create rugged interface with electronic device modules

(76) Inventors: Steven S. Homer, Tomball, TX (US); Ronald E. DeLuga, Spring, TX (US); Michele Bovio, Via Castellamonte (IT); Mark Ruch, Woodlands, TX (US); Jon Kolas, Tomball, TX (US)

Correspondence Address: Robert A. Van Someren, P.O. Box 692289, Houston, TX, 77269-2289, US

(21) Appl. No.: 10/127,006

(22) Filed: Apr. 19, 2002

(51) Int. Cl. G06F 1/16

(52) U.S. Cl. 361/683; 361/680

(57) ABSTRACT

A portable computer system comprising a portable computer with a rugged external bay interface. The bay interface facilitates the interchangeability of a variety of electronic device modules. The interface utilizes mechanical and electrical features that promote the use and interchangeability of the modules.

### FIELD OF THE INVENTION

The present invention relates generally to portable computers, such as notebook computers, and particularly to a rugged bay interface that allows users to remove and upgrade or interchange a variety of electronic device modules.

### BACKGROUND OF THE INVENTION

Portable computers utilize a variety of connectors and internal bays for attaching electronic devices. For example, PCMCIA card slots can be used to attach devices for performing desired additional functions. However, the PCMCIA card slot approach limits the flexibility of the design of modules that can be utilized with the portable computer. In existing systems, the interface does not facilitate rapid interchange of modules while maintaining a dependable, rugged connection. Also, the available space often limits the size and/or shape of any electronic device modules that may be attached to the computer. Additionally, internal bays tend to be constrained by shielding within the system which has a limiting effect on the ability to optimize antenna reception.

### SUMMARY OF THE INVENTION

The present invention relates generally to a system that facilitates the interchanging of a variety of peripheral electronic device modules for use in conjunction with a portable computer. The system provides a rugged interface that facilitates easy removal and attachment of a variety of modules at an external location. The modules are readily mechanically and electrically coupled and uncoupled with a module bay disposed along a back cover of the portable computer.

### BRIEF DESCRIPTION OF THE DRAWINGS

The invention will hereafter be described with reference to the accompanying drawings, wherein like reference numerals denote like elements, and:

FIG. 1 is a perspective view of an exemplary portable computer, such as a notebook computer, according to one embodiment of the present invention;

FIG. 2 is a perspective view of the portable computer of FIG. 1 with the display panel in an open position for use by an individual;

FIG. 3 is a perspective view of the back panel of the portable computer illustrated in FIG. 1 with an exemplary electronic device module attached;

FIG. 4 is an exploded view of a portion of the portable computer illustrated in FIG. 3;

FIG. 5 is an enlarged view of portions of the region captured by dashed line 5-5 of FIG. 4;

FIG. 6 is a cross-sectional view taken generally along line 6-6 of FIG. 3; and

FIG. 7 is a perspective view of an alternate embodiment of the portable computer illustrated in FIG. 1.

### DETAILED DESCRIPTION OF EXEMPLARY EMBODIMENTS

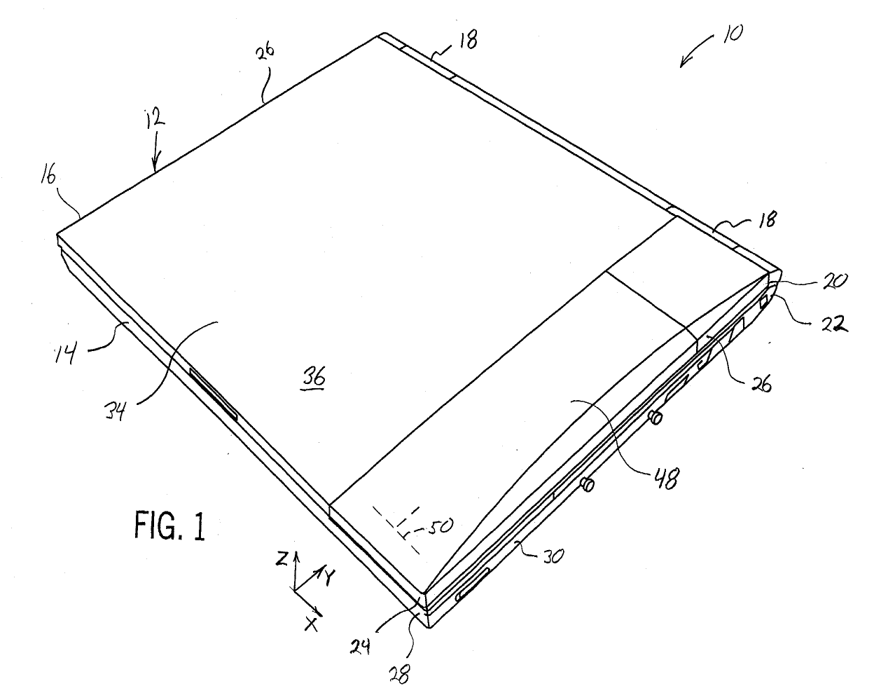

Referring generally to FIG. 1, a portable computer system 10 is illustrated. Computer system 10 comprises a portable computer 12, such as a notebook computer, which has a base 14 coupled to a display panel 16. Display panel 16 may be connected to base 14 in a variety of ways and by various mechanisms. However, one exemplary mechanism comprises one or more hinges 18 disposed generally at a first end 20 of display panel 16 and a first end 22 of base 14.

Generally opposite first end 20, display panel 16 has a second end 24. A pair of side edges 26 extend between first end 20 and second end 24 to define the general perimeter of display panel 16. Similarly, base 14 has a second end 28 and a pair of side edges 30 that extend generally between first end 22 and second end 24 to define a perimeter of base 14.

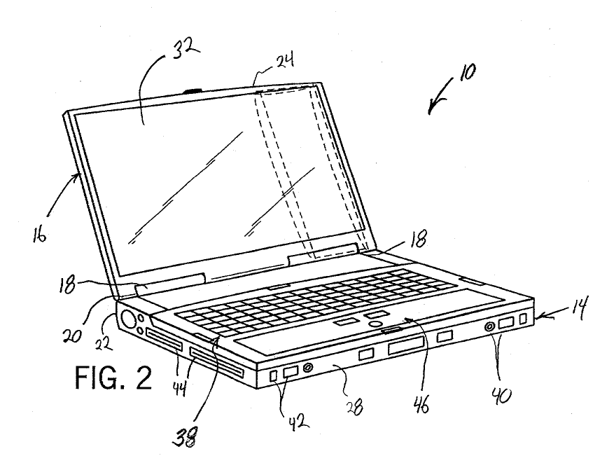

Hinge or hinges 18 allow display panel 16 to be pivoted between a closed position, as illustrated in FIG. 1, and an open position, as illustrated in FIG. 2. In the open position, a user is readily able to view a display screen 32 of display panel 16. In the open position, second end 24 is generally in an upward position relative to first end 20.

Opposite display screen 32, display panel 16 comprises a backcover 34 (see FIG. 1). In the exemplary embodiment, backcover 34 has a generally planar wall with an exterior surface 36. The exemplary backcover 34 lies substantially parallel with display screen 32 and may be formed from magnesium, a strong lightweight material. However, a variety of other materials, such as plastic and composite materials, may also be used in the formation of backcover 34.

Base 14 may include a keyboard 38, such as a removable keyboard to permit separation of the keyboard from the remainder of base 14. Additionally, base 14 includes or may include a variety of other features, such as interactive buttons 40, ports 42, drives 44, mouse pads 46 and other features that facilitate the use or adaptability of portable computer 12.

Portable computer system 10 also comprises a module 48 that is electrically and mechanically coupled to portable computer 12 via display panel 16. For example, module 48 may be connected to backcover 34 along exterior surface 36. In the embodiment illustrated in FIGS. 1 and 2, module 48 is mounted in a bay (discussed below) positioned along exterior surface 36 of backcover 34. Module 48 may, for example, be positioned to extend into the upper right hand corner of backcover 34 as determined from the perspective of a user when display panel 16 is in the open position.

Module 48 may be designed with one or more electronic devices for performing various functions. By mounting module 48 along exterior surface 36 of backcover 34, the module is unconstrained in the Z direction (see FIG. 1 in which the Z axis extends in a perpendicular direction with respect to exterior surface 36). Thus, multiple modules 48 with different thicknesses can readily be mounted to backcover 34.

In one exemplary system, portable computer 12 may be shipped with a simple cover similar to the outer shell of module 48 illustrated in FIG. 1. The cover is removable to permit the mounting of any of a variety of electronic device modules 48 to portable computer 12. This facilitates both the upgrading of modules as well as the interchange of a variety of different modules.

For example, because module 48 is mounted on the exterior of portable computer 12 and is not constrained by shielding, the design is readily adaptable for use with wireless communication devices or other devices that utilize an antennae 50. In the illustrated design, antennae 50 is disposed towards second end 24 of display panel 16. Thus, when display panel 16 is pivoted to its open or user position, as illustrated in FIG. 2, antennae 50 is disposed at a raised external location to facilitate reception and/or transmission.

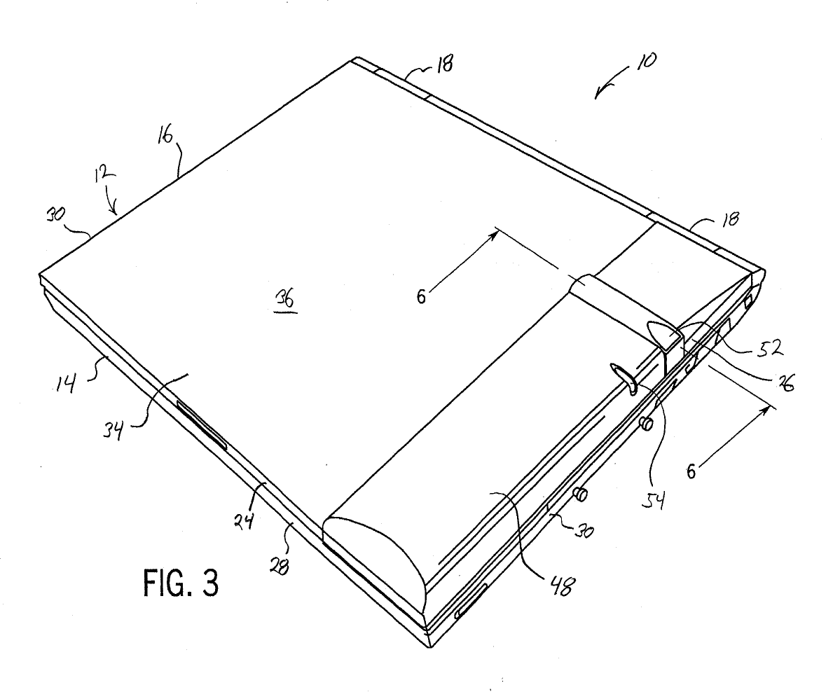

As further illustrated in FIG. 3, module 48 may have a variety of forms, shapes and thicknesses. Also, the module may comprise a variety of electronic devices, such as communication modules, e.g. Bluetooth modules and 802.11 standard wireless modules, as well as a variety of other types of modules including biometrics reader modules and video cameras. The module 48 illustrated in FIG. 3 is representative of these various types of devices that can be incorporated into portable computer system 10.

A given module 48 may have a variety of other features, such as release latch 52 and an LED or other visual indicator 54. Release latch 52 is used to avoid inadvertent separation of module 48 from display panel 16, and indicator 54 can be used to indicate a variety of events, such as connection between module 48 and portable computer 12 or the actual operation of module 48.

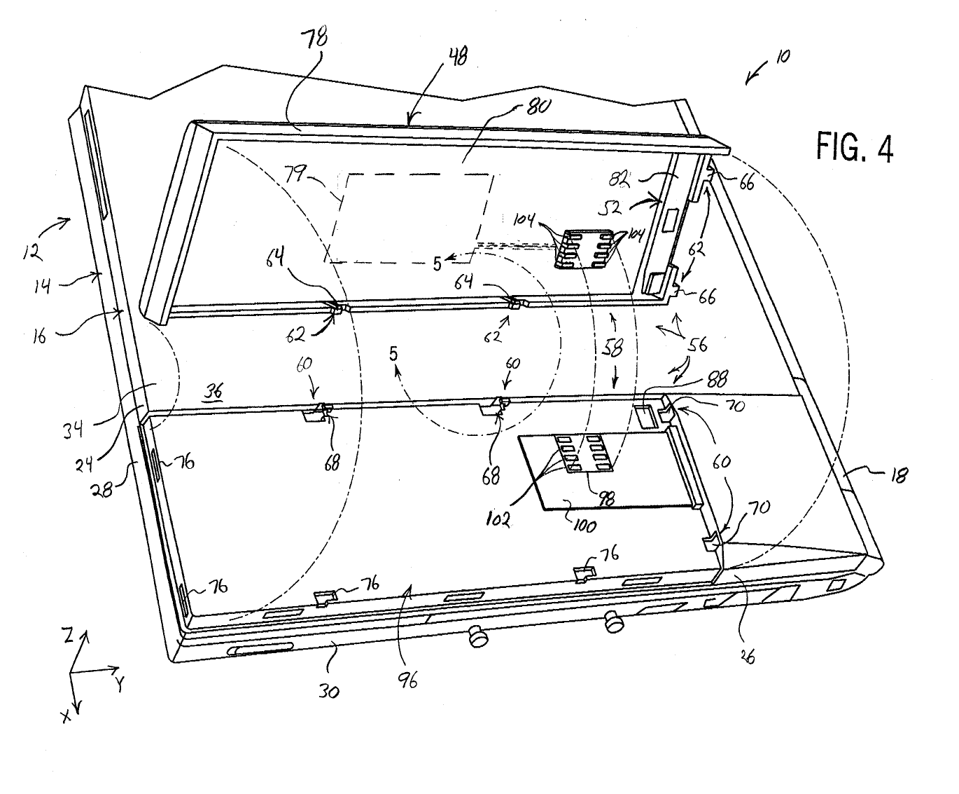

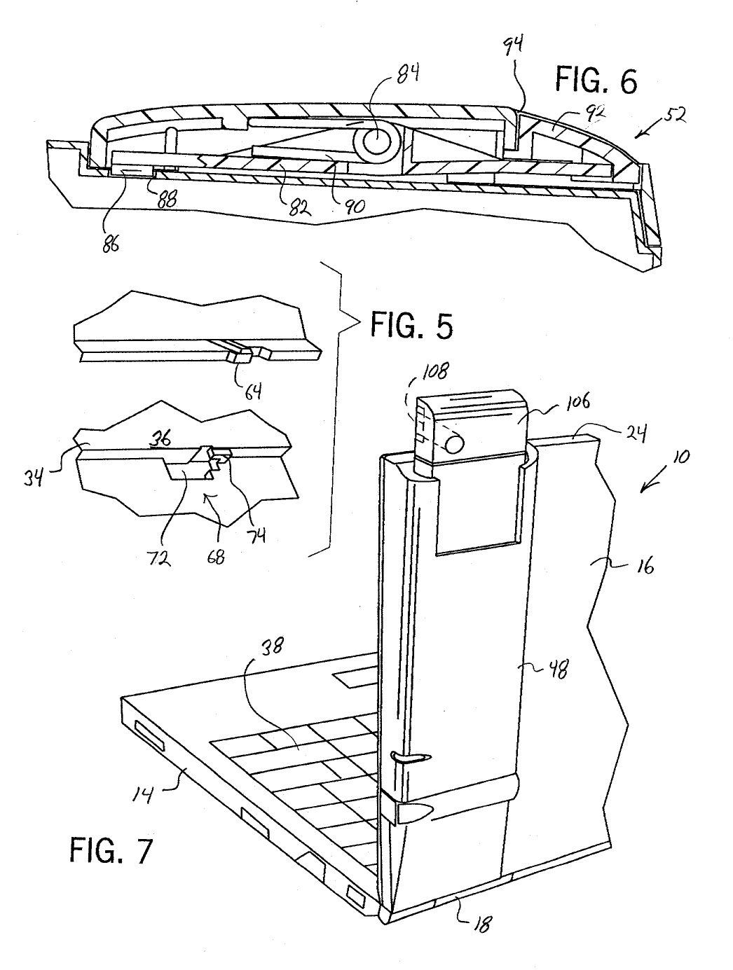

An exemplary mechanical interface 56 and electrical interface 58 is illustrated in FIG. 4. Mechanical interface 56 typically comprises a plurality of retention features 60 located in or on backcover 34 and corresponding retention features 62 formed as part of module 48. By way of specific example, corresponding retention features 62 comprise a plurality of hook members 64 (see also FIG. 5) and tabs 66. Hook members 64 and tabs 66 are received by retention features 60 and specifically by hook receptacles 68 and tab openings 70.

As illustrated best in FIG. 5, each hook receptacle 68 comprises a recess or opening 72 and a generally hook-shaped receiving portion 74. To attach module 48, hook members 64 are inserted into openings 72 and the module is slid laterally, e.g. in a Y direction, until hook members 64 engage hook-shaped receiving portions 74 to prevent movement of module 48 with respect to backcover 34 in a Z direction. Simultaneously, tabs 66 slide into tab openings 70 which further restrict movement and thus also help prevent inadvertent separation of module 48 from portable computer 12.

Depending on the required security of attachment, module weight, etc., additional retention features 76 can be added. Generally, the retention features are disposed at spaced locations in the X-Y plane to constrain the module in the X and Y directions while leaving the module thickness unconstrained in the Z direction.

The various retention features 62 of module 48 are attached to or formed as an integral part of an overall shell or housing structure 78. Housing structure 78 typically is formed of a relatively stiff material, such as a plastic material, that allows the forming, e.g. molding, of various retention features as integral portions of the overall housing structure 78. The housing structure 78 also functions to protect internal components of the module, such as various electronics 79 that may be provided on an appropriate printed circuit board 80. The actual internal components can vary substantially from one type of module to another, as would be known to those of ordinary skill in the art.

In at least some embodiments, inadvertent separation of module 48 from backcover 34 is further limited by release latch mechanism 52. An exemplary release latch mechanism 52 comprises a lever 82 pivotably mounted within housing structure 78, as illustrated best in FIGS. 4 and 6. Lever 82 may be pivotably connected to housing structure 78 by an appropriate pin 84 or other pivot structure. Lever 82 further comprises an engagement member 86 sized for receipt in a corresponding retention opening 88 formed in backcover 34. A spring 90 biases engagement member 86 into retention opening 88 when module 48 is attached to portable computer 12. Lever 82 further comprises a push button 92 exposed through an opening 94 of housing structure 78.

To release latch mechanism 52, the biasing force of spring 90 is overcome by applying a force against push button 92 until engagement member 86 is withdrawn from retention opening 88. Then, module 48 can be slid laterally and separated from backcover 34. In this manner, modules can be interchanged, repaired, upgraded or simply removed. The latch mechanism 52 and the various retention features provide a rugged mechanical interface between module 48 and portable computer 12 while permitting the easy interchange of modules.

Portable computer 12 is designed to create a panel bay 96 along exterior surface 36 of backcover 34 to facilitate this easy attachment and removal of desired modules at an external region of the computer also facilitates such functionality as reception and transmission of various wireless communications. Furthermore, the use of external panel bay 96 along backcover 34 promotes the ability to form a rugged mechanical interconnect between module 48 and portable computer 12. Panel bay 96 also provides flexibility in the design and formation of electrical interface 58.

For example, in the embodiment illustrated, panel bay 96 incorporates an electrical connector 98 disposed on an appropriate printed circuit card 100 electrically coupled with portable computer 12. One exemplary electrical connector 98 is a multiport USB connector, such as an 8-pin connector. In the configuration illustrated, electrical connector 98 comprises a plurality of connector pads 102 that are exposed along panel bay 96 for contact with corresponding contacts 104 of module 48. Corresponding contacts 104 are appropriately coupled to PC board 80 and protrude outwardly for contact with pads 102 when module 48 is coupled to backcover 34. By using connector pads 102 and protruding contacts 104, appropriate communicative contact between portable computer 12 and module 48 is formed when module 48 is moved into mechanical engagement with backcover 34 and slid laterally into its secured position.

Although a multiport USB interface works well for electrically coupling many types of modules 48 to portable computer 12, panel bay 96 may be designed to accommodate other or additional types of electrical interfaces. Additionally, the number of contacts or ports required or used can vary depending on the type of module, type of electrical interface and desired adaptability of the overall system.

Referring generally to FIG. 7, a modified embodiment of module 48 is illustrated in which the external form of the module has been changed to accommodate certain functionality. In this embodiment, module 48 further comprises an extended portion 106 that extends beyond the periphery of display panel 16. Specifically, portion 106 extends above second end 24. The use of such an extended portion 106 facilitates the use of, for instance, certain types of antennae or a video camera 108. In the embodiment illustrated, module 48 is a video camera module with video camera 108 disposed above display panel 16 to permit viewing of the computer system user.

While the invention is susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the appended claims.

What is claimed is:

1. A portable computer system, comprising:
a base;
a display panel having a backcover, the backcover comprising a panel bay.

2. The portable computer system as recited in claim 1, further comprising a module removably coupled to the panel bay.

3. The portable computer system as recited in claim 2, where in the module is constrained in two linear directions and unconstrained in the third linear direction.

4. The portable computer system as recited in claim 3, wherein the module comprises a multiport device.

5. The portable computer system as recited in claim 3, wherein the display panel further comprises a display screen, the panel bay being located in the upper right corner of the backcover when viewing the display screen.

6. The portable computer system as recited in claim 2, wherein the panel bay comprises a plurality of retention features and the module comprises a plurality of corresponding retention features positioned to engage the plurality of retention features.

7. The portable computer system as recited in claim 6, wherein the plurality of retention features comprises openings in the backcover.

8. The portable computer system as recited in claim 7, wherein the plurality of corresponding retention features comprises a plurality of hook protrusions sized for receipt in the openings.

9. The portable computer system as recited in claim 2, wherein the backcover comprises magnesium.

10. A portable computer system, comprising:
a base;
a display panel pivotably connected to the base, the display panel having a backcover with a multiport panel bay having a plurality of spaced retention features to receive a multiport device module.

11. The portable computer system as recited in claim 10, further comprising a multiport device module.

12. The portable computer system as recited in claim 11, wherein the multiport device module comprises an antennae.

13. The portable computer system as recited in claim 12, wherein the antennae extends beyond a periphery of the backcover.

14. The portable computer system as recited in claim 11, wherein the module comprises a Bluetooth module.

15. The portable computer system as recited in claim 11, wherein the module comprises a 802.11 standard wireless module.

16. The portable computer system as recited in claim 11, wherein the module comprises a biometrics reader module.

17. The portable computer system as recited in claim 11, wherein the module comprises a video camera.

18. A method of promoting the adaptability of a portable computer, comprising:
forming a panel bay on a backcover of a portable computer; and
selectively coupling a communications module to the panel bay.

19. The method as recited in claim 18, further comprising interchanging the communications module with another module having a different thickness than the communications module.

20. The method as recited in claim 18, wherein forming comprises locating a plurality of retention features on the backcover opposite a display screen of a portable computer.

21. The method as recited in claim 20, wherein locating the retention features comprises placing openings through the backcover.

22. The method as recited in claim 21, further comprising positioning a plurality of extended retention features on the communications module to engaged the openings.

23. The method as recited in claim 18, wherein selectively coupling comprises sliding the communications module along the backcover to engage the communications module with the portable computer.

24. The method as recited in claim 18, wherein selectively coupling comprises coupling a wireless communications module to the panel bay.

25. The method as recited in claim 18, wherein selectively coupling comprises coupling a 802.11 standard wireless module to the panel bay.

26. The method as recited in claim 18, further comprising orienting the communications module such that an antennae is at an upper end of the backcover when the portable computer is operated by an individual.

27. A system of promoting the adaptability of a portable computer, comprising:
means for forming a panel bay on a backcover of a portable computer; and
means for selectively coupling a communications module to the panel bay.

28. The system as recited in claim 27, wherein the means for forming comprises a plurality of retention features on the backcover opposite a display screen of a portable computer.

29. The system as recited in claim 28, wherein the means for selectively coupling comprises a module retention feature disposed on a wireless communications module.
